(19) United States
(12) Patent Application Publication
(10) Pub. No.: US 2024/0021211 A1
(43) Pub. Date: Jan. 18, 2024

(54) VOICE ATTRIBUTE MANIPULATION DURING AUDIO CONFERENCING

(71) Applicant: Avaya Management L.P., Durham, NC (US)

(72) Inventors: Pushkar Yashavant Deole, Pune (IN); Sandesh Chopdekar, Pune (IN); John Young, Hertfordshire (GB)

(21) Appl. No.: 17/866,037

(22) Filed: Jul. 15, 2022

(51) Int. Cl. G10L 21/003; H04N 7/14; H04N 7/15; G10L 25/90

(52) U.S. Cl. CPC G10L 21/003; H04N 7/147; H04N 7/152; G10L 25/90; G10L 2021/0135

(57) ABSTRACT

A method for manipulating voice attributes includes receiving, by a processor, a voice sample of a natural voice of a user, analyzing, by the processor, the voice sample for at least one attribute of the voice sample, receiving, by the processor, entered values for the at least one attribute of the voice sample and applying, by the processor, the entered values to the at least one attribute of the voice sample. The method further includes adjusting, by the processor, the at least one attribute of the voice sample based on the applied entered values to generate a manipulated voice sample, replacing, by the processor, the natural voice of the user with a modified voice of the user based on the manipulated voice sample and outputting, by the processor, the modified voice of the user.

### FIELD

The present disclosure relates generally to systems and methods for multi-participant communication conferencing and particularly relates to systems and methods for voice attribute manipulation during multi-participant communication conferencing.

### BACKGROUND

Digital conference meetings are the new normal as organizations all over the world are in the process of promoting the work-from-anywhere culture. These organizations not only include corporate organizations but also schools, colleges, courts etc. As compared with face-to-face meetings, there are many challenges associated with virtual digital meetings as user experiences in this area have not been favorable. For example, a teacher that conducts a lesson to students or a moderator of an online webinar each experiences many challenges. In such cases, the person giving the lecture may desire his voice to be received in a way that would provide the most impact on listeners. Moreover, the listeners would get the most out of the lecture even when they are not communicating in person. Also in some other circumstances, a speaker may not possess natural voice qualities such as desired pitch, tone, throw, resonance which are required to be a good speaker. Therefore, it is difficult for a speaker without these desired characteristics to effectively convey their thoughts especially during audio conferencing calls. Video calls fair no better since these calls also do not provide for face-to-face communication.

Moreover, some individuals may experience voice disorders which affect the voice quality of these individuals. Therefore, it becomes even more difficult for these individuals to participate in digital meetings and convey their thoughts in an appropriate manner as compared to conducting in-person meetings or lectures.

Lastly, in the same way that a person's image can be manipulated using various imaging technologies for posting enhanced images on social media networking sites, it would be desirable if a person's voice attributes can also be manipulated to achieve the same enhanced results during virtual meetings or while posting on social media networking sites.

One conventional technique used to manipulate a person's voice is voice cloning. Voice cloning replaces the natural voice of a person with a cloned synthetic voice of another person or machine. This technique, however, does not allow a person to maintain his natural voice and does not allow a person to independently adjust the attributes of his natural voice. Audio/voice deepfake generation is another conventional technique used to manipulate a person's voice. An audio/voice deepfake is content or material that is synthetically generated or manipulated using Artificial Intelligence (AI) to be passed off as real. Audio/voice deepfakes also do not allow a person to independently adjust the attributes of his natural voice.

Therefore, there is a need for systems and methods for voice attribute manipulation during multi-participant communication conferencing.

### SUMMARY

These and other needs are addressed by the various embodiments and configurations of the present disclosure. The present disclosure can provide a number of advantages depending on the particular configuration. These and other advantages will be apparent from the disclosure contained therein.

The phrases “at least one”, “one or more”, and “and/or” are open-ended expressions that are both conjunctive and disjunctive in operation. For example, each of the expressions “at least one of A, B and C”, “at least one of A, B or C”, “one or more of A, B and C”, “one or more of A, B or C” and “A, B and/or C” means A alone, B alone, C alone, A and B together, A and C together, B and C together or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “conference” as used herein refers to any communication or set of communications, whether including audio, video, text or other multimedia data, between two or more communication endpoints and/or users. Typically, a conference includes two or more communication endpoints. The terms “conference” and “conference call” are used interchangeably throughout the specification.

The term “communication device” or “communication endpoint” as used herein refers to any hardware device and/or software operable to engage in a communication session. For example, a communication device can be an Internet Protocol (IP)-enabled phone, a desktop phone, a cellular phone, a personal digital assistant, a soft-client telephone program executing on a computer system, etc. IP-capable hard- or softphone can be modified to perform the operations according to embodiments of the present disclosure.

The term “network” as used herein refers to a system used by one or more users to communicate. The network can consist of one or more session managers, feature servers, communication endpoints, etc. that allow communications, whether voice or data, between two users. A network can be any network or communication system as described in conjunction with FIG. 1. Generally, a network can be a Local Area Network (LAN), a Wide Area Network (WAN), a wireless LAN, a wireless WAN, the Internet, etc. that receives and transmits messages or data between devices. A network may communicate in any format or protocol known in the art, such as. Transmission Control Protocol/IP (TCP/IP), 802.11g, 802.11n, Bluetooth or other formats or protocols.

The term “communication event” and its inflected forms includes: (i) a voice communication event, including but not limited to a voice telephone call or session, the event being in a voice media format or (ii) a visual communication event, the event being in a video media format or an image-based media format or (iii) a textual communication event, including but not limited to instant messaging, internet relay chat, e-mail, short-message-service, Usenet-like postings, etc., the event being in a text media format or (iv) any combination of (i), (ii), and (iii).

The term “communication system” or “communication network” and variations thereof, as used herein, can refer to a collection of communication components capable of one or more of transmission, relay, interconnect, control or otherwise manipulate information or data from at least one transmitter to at least one receiver. As such, the communication may include a range of systems supporting point-to-point or broadcasting of the information or data. A communication system may refer to the collection of individual communication hardware as well as the interconnects associated with and connecting the individual communication hardware. Communication hardware may refer to dedicated communication hardware or may refer to a processor coupled with a communication means (i.e., an antenna) and running software capable of using the communication means to send and/or receive a signal within the communication system. Interconnect refers to some type of wired or wireless communication link that connects various components, such as communication hardware, within a communication system. A communication network may refer to a specific setup of a communication system with the collection of individual communication hardware and interconnects having some definable network topography. A communication network may include wired and/or wireless network having a pre-set to an ad hoc network structure.

The term “computer-readable medium” as used herein refers to any tangible storage and/or transmission medium that participate in providing instructions to a processor for execution. The computer-readable storage medium may be, for example, but not limited to, an electronic, magnetic, optical, electromagnetic, infrared or semiconductor system, apparatus or device or any suitable combination of the foregoing. More specific examples (a non-exhaustive list) of the computer-readable storage medium would include the following: an electrical connection having one or more wires, a portable computer diskette, a hard disk, etc. Such a medium may take many forms, including but not limited to, non-volatile media, volatile media and transmission media. Non-volatile media includes, for example, Non-Volatile Random-Access Memory (NVRAM) or magnetic or optical disks. Volatile media includes dynamic memory, such as main memory. Common forms of computer-readable media include, for example, a floppy disk, a flexible disk, a hard disk, a magnetic tape or any other magnetic medium, magneto-optical medium, a Compact Disk-Read Only (CD-ROM), any other optical medium, punch cards, a paper tape, any other physical medium with patterns of holes, a RAM, a Programmable ROM (PROM), an Erasable PROM (EPROM), a Flash-EPROM, a solid state medium like a memory card, any other memory chip or cartridge, a carrier wave as described hereinafter or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate or transport a program for use by or in connection with an instruction execution system, apparatus or device. Program code embodied on a computer readable medium may be transmitted using any appropriate medium, including but not limited to wireless, wireline, optical fiber cable, Radio-frequency (RF), etc. or any suitable combination of the foregoing.

A “database” is an organized collection of data held in a computer. The data is typically organized to model relevant aspects of reality (for example, the availability of specific types of inventories), in a way that supports processes requiring this information (for example, finding a specified type of inventory). The organization schema or model for the data can, for example, be hierarchical, network, relational, entity-relationship, object, document, XML, entity-attribute-value model, star schema, object-relational, associative, multidimensional, multi-value, semantic and other database designs. Database types include, for example, active, cloud, data warehouse, deductive, distributed, document-oriented, embedded, end-user, federated, graph, hypertext, hypermedia, in-memory, knowledge base, mobile, operational, parallel, probabilistic, real-time, spatial, temporal, terminology-oriented and unstructured databases. Database management system (DBMS)s are specially designed applications that interact with the user, other applications, and the database itself to capture and analyze data.

The terms “determine”, “calculate” and “compute” and variations thereof, are used interchangeably and include any type of methodology, process, mathematical operation or technique.

The term “electronic address” refers to any contactable address, including a telephone number, instant message handle, e-mail address, Universal Resource Locator (URL), Universal Resource Identifier (URI), Address of Record (AOR), electronic alias in a database, like addresses and combinations thereof.

An “enterprise” refers to a business and/or governmental organization, such as a corporation, partnership, joint venture, agency, military branch and the like.

A geographic information system (GIS) is a system to capture, store, manipulate, analyze, manage and present all types of geographical data. A GIS can be thought of as a system—it digitally makes and “manipulates” spatial areas that may be jurisdictional, purpose or application-oriented. In a general sense, GIS describes any information system that integrates, stores, edits, analyzes, shares and displays geographic information for informing decision making.

The terms “instant message” and “instant messaging” refer to a form of real-time text communication between two or more people, typically based on typed text. Instant messaging can be a communication event.

The term “internet search engine” refers to a web search engine designed to search for information on the World Wide Web and File Transfer Protocol (FTP) servers. The search results are generally presented in a list of results often referred to as Search Engine Results Pages (SERPS). The information may consist of web pages, images, information and other types of files. Some search engines also mine data available in databases or open directories. Web search engines work by storing information about many web pages, which they retrieve from the html itself. These pages are retrieved by a Web crawler (sometimes also known as a spider)—an automated Web browser which follows every link on the site. The contents of each page are then analyzed to determine how it should be indexed (for example, words are extracted from the titles, headings, or special fields called meta tags). Data about web pages are stored in an index database for use in later queries. Some search engines, such as Google™, store all or part of the source page (referred to as a cache) as well as information about the web pages, whereas others, such as AltaVista™, store every word of every page they find.

The term “means” as used herein shall be given its broadest possible interpretation in accordance with 35 U.S.C., Section 112, Paragraph 6. Accordingly, a claim incorporating the term “means” shall cover all structures, materials or acts set forth herein, and all of the equivalents thereof. Further, the structures, materials or acts and the equivalents thereof shall include all those described in the summary of the invention, brief description of the drawings, detailed description, abstract and claims themselves.

The term “module” as used herein refers to any known or later developed hardware, software, firmware, artificial intelligence, fuzzy logic or combination of hardware and software that is capable of performing the functionality associated with that element.

A “server” is a computational system (e.g., having both software and suitable computer hardware) to respond to requests across a computer network to provide, or assist in providing, a network service. Servers can be run on a dedicated computer, which is also often referred to as “the server”, but many networked computers are capable of hosting servers. In many cases, a computer can provide several services and have several servers running. Servers commonly operate within a client-server architecture, in which servers are computer programs running to serve the requests of other programs, namely the clients. The clients typically connect to the server through the network but may run on the same computer. In the context of IP networking, a server is often a program that operates as a socket listener. An alternative model, the peer-to-peer networking module, enables all computers to act as either a server or client, as needed. Servers often provide essential services across a network, either to private users inside a large organization or to public users via the Internet.

The term “social network” refers to a web-based social network maintained by a social network service. A social network is an online community of people, who share interests and/or activities or who are interested in exploring the interests and activities of others.

The term “sound” or “sounds” as used herein refers to vibrations (changes in pressure) that travel through a gas, liquid or solid at various frequencies. Sound(s) can be measured as differences in pressure over time and include frequencies that are audible and inaudible to humans and other animals. Sound(s) may also be referred to as frequencies herein.

The terms “audio output level” and “volume” are used interchangeably and refer to the amplitude of sound produced when applied to a sound producing device.

The term “multi-party” as used herein may refer to communications involving at least two parties. Examples of multi-party calls may include, but are in no way limited to, person-to-person calls, telephone calls, conference calls, communications between multiple participants and the like.

The terms “voice characteristics”, “voice attributes”, and “voice qualities” are used interchangeably and refer to the features found in a person's voice.

The term “artificial intelligence” (AI), as used herein, generally refers to machine intelligence that includes a computer model or algorithm that may be used to provide actionable insight, make a prediction, and/or control actuators. The AI may be a machine learning algorithm. The machine learning algorithm may be a trained machine learning algorithm, e.g., a machine learning algorithm trained from data. Such a trained machine learning algorithm may be trained using supervised, semi-supervised, or unsupervised learning processes. Examples of machine learning algorithms include neural networks, support vector machines and reinforcement learning algorithms.

Aspects of the present disclosure may take the form of an entirely hardware embodiment, an entirely software embodiment (including firmware, resident software, micro-code, etc.) or an embodiment combining software and hardware aspects that may al generally be referred to herein as a “circuit”, “module” or “system”. Any combination of one or more computer readable medium(s) may be utilized. The computer readable medium may be a computer readable signal medium or a computer readable storage medium.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K. 22 nm Ivy Bridge, the AMD® FX™ family of processors, AMD® FX-4300, FX-6300 and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIVI926EJ-S™ processors, other industry-equivalent processors, and may perform computational functions using any known or future-developed standard, instruction set, libraries and/or architecture.

The ensuing description provides embodiments only and is not intended to limit the scope, applicability or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description including an element number, without a sub element identifier when a sub element identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

The preceding is a simplified summary of the disclosure to provide an understanding of some aspects of the disclosure. This summary is neither an extensive nor exhaustive overview of the disclosure and its various aspects, embodiments and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The present disclosure will be described in conjunction with the appended figures.

FIG. 1A is a block diagram of a first illustrative communication system used for voice attribute manipulation during a communication session according to embodiments of the present disclosure.

FIG. 1B is a block diagram of a second illustrative communication system used for voice attribute manipulation during a communication session according to embodiments of the present disclosure.

FIG. 2 is a block diagram of an illustrative conferencing server provided in a communication system used for voice attribute manipulation during a communication session according to embodiments of the present disclosure.

FIG. 3 is a block diagram of an illustrative communication device provided in a communication system used for voice attribute manipulation during a communication session according to embodiments of the present disclosure.

FIG. 4 is a tabular representation of database entries provided by participants or retrieved automatically from one or more data sources and used for voice attribute manipulation during a communication session according to embodiments of the present disclosure.

FIG. 5A-5F illustrate aspects of voice modifier interfaces that can be displayed on a communication device used for voice attribute manipulation during a communication session according to embodiments of the present disclosure.

FIG. 6 is a flow diagram of a method used for voice attribute manipulation during a communication session according to embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. Various changes may be made in the function and arrangement of elements without departing from the spirit and scope of the present disclosure.

According to embodiments of the present disclosure, a method for manipulating voice attributes of a speaker includes receiving a voice sample of a natural voice of the speaker and analyzing the voice sample of the speaker for attributes of the voice sample. The method also includes receiving entered values for the attributes of the voice sample and applying the entered values to the attributes of the voice sample. The method further includes adjusting the attributes of the voice sample based on the applied entered values to generate a manipulated voice sample. Moreover, the method includes replacing the natural voice of the speaker with a modified voice of the speaker based on the manipulated voice sample and outputting the modified voice of the speaker.

A person's manipulated voice qualities or voice attributes can be used in a communication session such as for example, in a contact center communication session or during a conference call to manipulate the speech of a person by molding the speech into different voice attributes so it sounds more suitable for a given audience. A voice attribute manipulation module can be applied to adjust several voice characteristics/attributes of a speaker such as pitch, volume, intensity, tone, vocal fry, rhythm etc. among others, in order for the speaker to be heard differently by an audience than the speaker would normally be heard using his natural voice.

According to embodiments of the present disclosure, a voice analyzer is used wherein the speaker records a voice sample. The recorded voice sample passes through the voice analyzer and the voice analyzer identifies different voice attributes. The different voice attributes are provided with specific values based on the recorded voice sample. The specific values are displayed to the speaker based on a scale. The speaker will be allowed to adjust each voice attribute of the voice sample and the voice attribute manipulation module would manipulate the voice sample based on the adjusted voice attributes. A modified voice of the speaker based on the adjusted voice attributes is played back to the speaker so that the speaker can listen to the changes (e.g., the adjusted voice attributes) in the speaker's voice.

According to embodiments of the present disclosure, a first feature is to record a voice sample of the speaker. The speaker records a voice sample in his natural voice. This will include the natural voice attributes associated with the speaker's natural voice. The recorded voice sample is then analyzed for various voice attributes such as pitch, intensity, vocal fry etc. through a voice analyzer module, and the speaker is given the opportunity to change the values for one or more of the voice attributes by providing a scale that can be adjusted by the user. For example, the user may adjust a value for his pitch from the recorded voice sample from a value of 2 to a value of 7 based on a scale of values from 1 to 10 for example.

According to embodiments of the present disclosure, a second feature is to change the voice attributes of the recorded voice sample. After the speaker adjusts the values for the voice attributes, the voice attribute manipulation module changes the voice sample according to the new values for the voice attributes selected by the user. The modified voice of the speaker is played back to the speaker. The speaker can adjust different values or multiple values for the different voice attributes until the speaker finds the best modified voice for the speaker.

According to embodiments of the present disclosure, practical situations exist as to why a particular speaker would want to manipulate his voice attributes to generate a modified voice. For example, a speaker that wants to impress an audience or show more authority by adjusting his pitch is a reason why a speaker would want to manipulate his voice attributes to generate a modified voice. Another example includes speakers manipulating their voice attributes to generate a modified voice to reflect a difference in their character. For example, people that want to be more charismatic, may manipulate their voice attributes.

According to example embodiments of the present disclosure, a teacher that desires to sound more confident or demonstrate authority when speaking with students or a chief executive officer that desires to speak with authority when communicating with employees during an online meeting would manipulate one or more voice attributes (e.g., lower the pitch) since research suggests speaking with a lower pitch makes the speaker sound more competent, stronger and trustworthy compared to speaking with a very high pitch which makes the speaker sound weak and less trustworthy.

According to another example embodiment of the present disclosure, a politician that desires to sound more charismatic to his constituents would manipulate one or more voice attributes (e.g., alter the voice frequency) since research suggests speaking with lower frequency makes the speaker sound more trustworthy.

According to another example embodiment of the present disclosure, an employee attending a very early morning or very late-night meeting, or if the meeting is extended and prolonged when the employee is feeling drowsy or tired, but still wants to be perceived by other members to the meeting as being cheerful or energetic would manipulate one or more voice attributes (e.g., alter the pitch or the tone) to be perceived differently than the actual state of the employee.

In another variation, the voice sample would be altered by the voice attribute manipulation module and converted into multiple voice samples, with each of the multiple voice samples corresponding to a respective permutation/combination of various voice attributes. The user would then be able to select a voice sample with the voice attribute combination that the user would like to be heard by his audience.

In another variation, the voice attribute/characteristic manipulation is used in a communication session such as a conference meeting or a one-on-one communication session, (e.g., a video or voice call, etc.). The other party to the communication session would be notified either through a visual notification indicator or through an audible notification, that the speaker has chosen to manipulate some or all of his voice characteristics and is speaking with a modified voice.

In a further variation, attributes of desired voices can be gathered. For example, studies of voices of influential personalities from different fields from all over the world can be conducted regarding different voice attributes. A machine learning model can be applied to the voice attributes along with a perception of the desired voices. When a user selects a particular perception, the corresponding voice attributes for that perception are then applied to the user's voice sample and the attributes of the user's voice sample are manipulated accordingly. The speaker is allowed to first hear the voice attributes manipulated according to the user's selection and the user is then given the opportunity to change the selection in case the user desires to make a different selection.

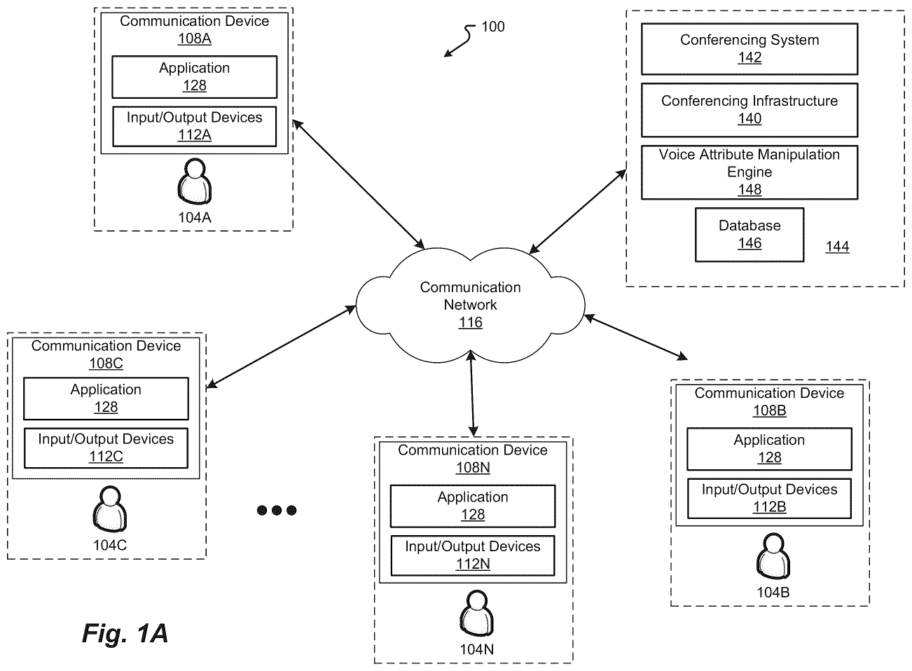

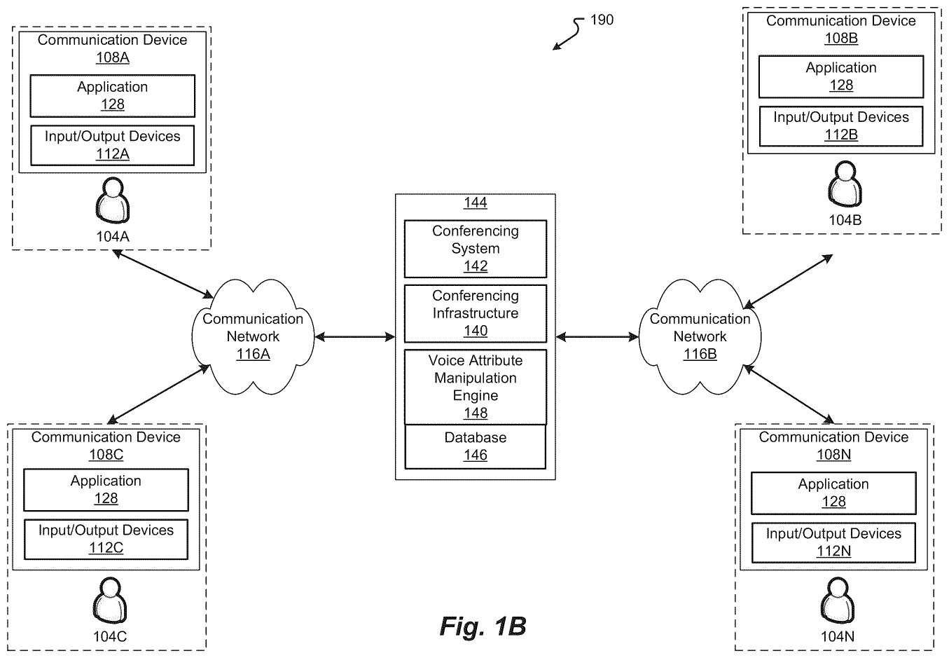

FIG. 1 is a block diagram of a first illustrative communication system 100 used for voice attribute manipulation during a communication session according to embodiments of the present disclosure. Referring to FIG. 1, the communication system 100 is illustrated in accordance with at least one embodiment of the present disclosure. The communication system 100 may allow a user 104A to participate in the communication system 100 using a communication device 108A having an input/output device 112A and an application 128. As used herein, the communication devices include user devices. Other users 104B and 104C to 104N also can participate in the communication system 100 using respective communication devices 108B, 108C through 108N having input/output devices 112B, 112C to 112N and applications 128. In accordance with embodiments of the present disclosure, one or more of the users 104A-104N may access a conferencing system 142 utilizing the communication network 116.

As discussed in greater detail below, the input/output devices 112A to 112N, may include one or more audio input devices, audio output devices, video input devices and/or video output devices. In some embodiments of the present disclosure, the audio input/output devices 112A-112N may be separate from the communication devices 108A-108N. For example, an audio input device may include, but is not limited to, a receiver microphone used by the communication device 108A, as part of the communication device 108A and/or an accessory (e.g., a headset, etc.) to convey audio to one or more of the other communication devices 108B-108N and the conferencing system 142. In some cases, the audio output device may include, but is not limited to speakers, which are part of a headset, standalone speakers or speakers integrated into the communication devices 108A-108N.

Video input devices, such as cameras may correspond to an electronic device capable of capturing and/or processing an image and/or a video content. The cameras may include suitable logic, circuitry, interfaces and/or code that may be operable to capture and/or process an image and/or a video content.

The communication network 116 may be packet-switched and/or circuit-switched. An illustrative communication network 116 includes, without limitation, a Wide Area Network (WAN), such as the Internet, a Local Area Network (LAN), a Personal Area Network (PAN), a Public Switched Telephone Network (PSTN), a Plain Old Telephone Service (POTS) network, a cellular communications network, an Internet Protocol Multimedia Subsystem (IMS) network, a Voice over Internet Protocol (VoIP) network, a Session Initiated Protocol (SIP) network or combinations thereof. The Internet is an example of the communication network 116 that constitutes an Internet Protocol (IP) network including many computers, computing networks, and other communication devices located all over the world, which are connected through many telephone systems and other means. In one configuration, the communication network 116 is a public network supporting the Transmission Control Protocol/IP (TCP/IP) suite of protocols. Communications supported by the communication network 116 include real-time, near-real-time, and non-real-time communications. For instance, the communication network 116 may support voice, video, text, web-conferencing, or any combination of media. Moreover, the communication network 116 may include a number of different communication media such as coaxial cable, copper cable/wire, fiber-optic cable, antennas for transmitting/receiving wireless messages and combinations thereof. In addition, it can be appreciated that the communication network 116 need not be limited to any one network type, and instead may include a number of different networks and/or network types. It should be appreciated that the communication network 116 may be distributed. Although embodiments of the present disclosure will refer to one communication network 116, it should be appreciated that the embodiments of the present disclosure claimed herein are not so limited. For instance, more than one communication network 116 may be joined by combinations of servers and networks.

The term “communication device” as used herein is not limiting and may be referred to as a user device and mobile device, and variations thereof. A communication device, as used herein, may include any type of device capable of communicating with one or more other device and/or across a communications network, via a communications protocol and the like. A communication device may include any type of known communication equipment or collection of communication equipment. Examples of an illustrative communication device may include, but are not limited to, any device with a sound and/or pressure receiver, a cellular phone, a smart phone, a telephone, handheld computers, laptops, netbooks, notebook computers, subnotebooks, tablet computers, scanners, portable gaming devices, pagers, Global Positioning System (GPS) modules, portable music players and other sound and/or pressure receiving devices. A communication device does not have to be Internet-enabled and/or network-connected. In general, each communication device may provide many capabilities to one or more users who desire to use or interact with the conferencing system 142. For example, a user may access the conferencing system 142 utilizing the communication network 116.

Capabilities enabling the disclosed systems and methods may be provided by one or more communication devices through hardware or software installed on the communication device, such as the application 128. For example, the application 128 may be in the form of a communication application and can be used to manipulate the voice attributes of a speaker during a communication session.

In some embodiments of the present disclosure, the conferencing system 142 may reside within a server 144. The server 144 may be a server that is administered by an enterprise associated with the administration of communication device(s) or owning communication device(s), or the server 144 may be an external server that can be administered by a third-party service, meaning that the entity which administers the external server is not the same entity that either owns or administers a communication device. In some embodiments of the present disclosure, an external server may be administered by the same enterprise that owns or administers a communication device. As one particular example, a communication device may be provided in an enterprise network and an external server may also be provided in the same enterprise network. As a possible implementation of this scenario, the external server may be configured as an adjunct to an enterprise firewall system, which may be contained in a gateway or Session Border Controller (SBC) which connects the enterprise network to a larger unsecured and untrusted communication network. As an example, the server may be a unified messaging server that consolidates and manages multiple types, forms, or modalities of messages, such as voice mail, e-mail, short-message-service text message, instant message, video call and the like. As another example, a conferencing server is a server that connects multiple participants to a conference call. As illustrated in FIG. 1, the server 144 includes a conferencing system 142, a conferencing infrastructure 140, a voice attribute manipulation engine 148 and a database 146.

Although various modules and data structures for the disclosed systems and methods are depicted as residing on the server 144, one skilled in the art can appreciate that one, some, or all of the depicted components of the server 144 may be provided by other software or hardware components. For example, one, some, or all of the depicted components of the server 144 may be provided by logic on a communication device (e.g., the communication device may include logic for the systems and methods disclosed herein so that the systems and methods are performed locally at the communication device). Further, the logic of application 128 can be provided on the server 144 (e.g., the server 144 may include logic for the systems and methods disclosed herein so that the systems and methods are performed at the server 144). In embodiments of the present disclosure, the server 144 can perform the methods disclosed herein without use of logic on any of the communication devices 108A-108N.

The conferencing system 142 implements functionality for the systems and methods described herein by interacting with two or more of the communication devices 108A-108N, the application 128, the conferencing infrastructure 140, the voice attribute manipulation engine 148 and the database 146 and/or other sources of information as discussed in greater detail below that can allow two or more communication devices 108 to participate in a multi-party call. In some embodiments of the present disclosure the voice attribute manipulation engine 148 can also be part of the conferencing system application executing on the user's device. One example of a multi-party call includes, but is not limited to, a person-to-person call, a conference call between two or more users/parties and the like. Although some embodiments of the present disclosure are discussed in connection with multi-party calls, embodiments of the present disclosure are not so limited. Specifically, the embodiments disclosed herein may be applied to one or more of audio, video, multimedia, conference calls, web conferences and the like.

In some embodiments of the present disclosure, the conferencing system 142 can include one or more resources such as the conferencing infrastructure 140 as discussed in greater detail below. As can be appreciated, the resources of the conferencing system 142 may depend on the type of multi-party call provided by the conferencing system 142. Among other things, the conferencing system 142 may be configured to provide conferencing of at least one media type between any number of the participants. The conferencing infrastructure 140 can include hardware and/or software resources of the conferencing system 142 that provide the ability to hold multi-party calls, conference calls and/or other collaborative communications.

In some embodiments of the present disclosure, the voice attribute manipulation engine 148 is used to modify the voice of one or more of the users 104A-104N. This is accomplished by receiving a voice sample of a natural voice of the one or more of the users 104A-104N and analyzing the voice sample of the one or more of the users 104A-104N for attributes of the voice sample. This is also accomplished by receiving entered values for the attributes of the voice sample and applying the entered values to the attributes of the voice sample. This is further accomplished by adjusting the attributes of the voice sample based on the applied entered values to generate a manipulated voice sample, replacing the natural voice of the one or more of the users 104A-104N with a modified voice of the one or more of the users 104A-104N based on the manipulated voice sample and outputting the modified voice of the one or more of the users 104A-104N.

As discussed in greater detail below, the voice attribute manipulation engine 148 includes several components, including an audio analyzer, a voice recorder, an artificial intelligence module and a voice attribute manipulation module as discussed in greater detail below.

The database 146 may include information pertaining to one or more of the users 104A-104N, communication devices 108A-108N, and conferencing system 142, among other information. For example, the database 146 includes voice samples and manipulated voice samples for each of the participants of a communication session. Moreover, the database 146 may store attribute selections of the user for various voice attributes.

The conferencing infrastructure 140 and the voice attribute manipulation engine 148 may allow access to information in the database 146 and may collect information from other sources for use by the conferencing system 142. In some instances, data in the database 146 may be accessed utilizing the conferencing infrastructure 140, the voice attribute manipulation engine 148 and the application 128 running on one or more of the communication devices, such as the communication devices 108A-108N.

The application 128 may be executed by one or more of the communication devices (e.g., the communication devices 108A-108N) and may execute all or part of the conferencing system 142 at one or more of the communication devices 108A-108N by accessing data in the database 146 using the conferencing infrastructure 140 and the voice attribute manipulation engine 148. Accordingly, a user may utilize the application 128 to access and/or provide data to the database 146. For example, a user 104B may utilize the application 128 executing on the communication device 108B to record his/her voice sample(s) and generate one or more manipulated voice samples prior to engaging in a communication session with participants 104A and 104C-104N. Such data may be received at the conferencing system 142 and associated with one or more profiles associated with the user 104B and the other participants 104C-104N to the conference call and stored in the database 146.

FIG. 1B is a block diagram of a second illustrative communication system 190 used for voice attribute manipulation during a communication session according to embodiments of the present disclosure. The second illustrative system 190 includes user communication device 108A, 108B, 108C and 108N, networks 116A-116B and server 144. In FIG. 1B, network 116A is typically a public network, such as the Internet. Network 116B is typically a private network, such as, a corporate network. In FIG. 1B, the server 144 is typically used to send communication messages between communication devices 108A and 108C and communication devices 108B and 108N.

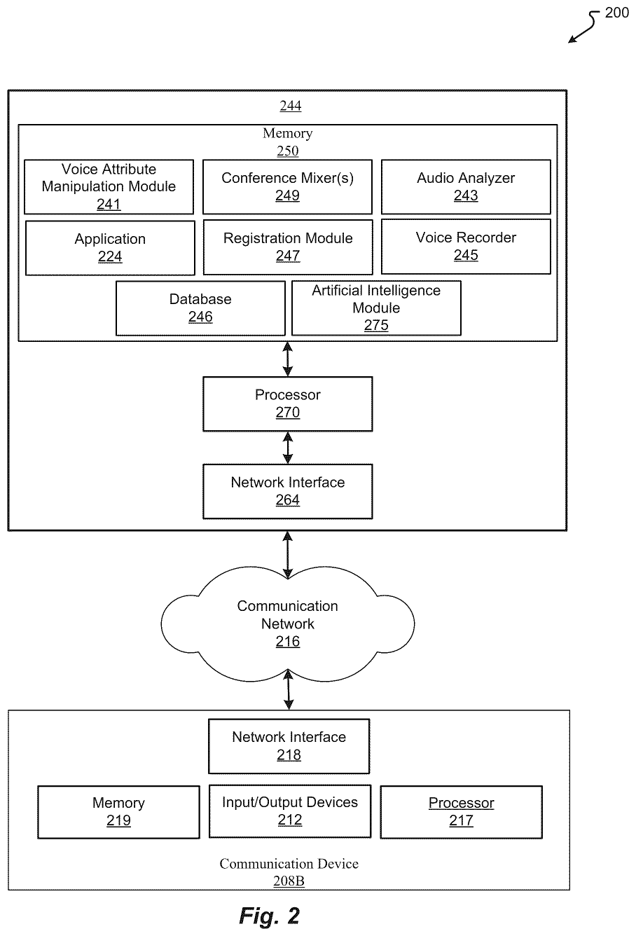

FIG. 2 is a block diagram of an illustrative conferencing server 244 provided in a communication system 200 used for voice attribute manipulation during a communication session according to embodiments of the present disclosure. Referring to FIG. 2, the communication system 200 is illustrated in accordance with at least one embodiment of the present disclosure. The communication system 200 may allow users to participate in a conference call with other users. The conferencing server 244 implements functionality establishing the communication session for the systems and methods described herein by interacting with the communication devices (including its hardware and software components) and the various components of the conferencing server 244. For example, the conferencing server 244 includes a memory 250 and a processor 270. Furthermore, the conferencing server 244 includes a network interface 264. The memory 250 includes a database 246, an application 224 (used in conjunction with the application 128 of the communication devices 108A-108N), conference mixer(s) 249 (part of the conferencing infrastructure 140 illustrated in FIG. 1), an audio analyzer 243, a voice recorder 245, a registration module 247, a voice attribute manipulation module 241 and an artificial intelligence module 275.

The processor 270 may include a microprocessor, a Central Processing Unit (CPU), a collection of processing units capable of performing serial or parallel data processing functions and the like. The memory 250 may include a number of applications or executable instructions that are readable and executable by the processor 270. For example, the memory 250 may include instructions in the form of one or more modules and/or applications such as application 224. The memory 250 may also include data and rules in the form of settings that can be used by one or more of the modules and/or applications described herein. The memory 250 may also include one or more communication applications and/or modules, which provide communication functionality of the conferencing server 244. In particular, the communication application(s) and/or module(s) may contain the functionality necessary to enable the conferencing server 244 to communicate with communication device 208B as well as other communication devices (not shown) across the communication network 216. As such, the communication application(s) and/or module(s) may have the ability to access communication preferences and other settings, maintained within the database 246, the registration module 247 and/or the memory 250, format communication packets for transmission via the network interface 264, as well as condition communication packets received at the network interface 264 for further processing by the processor 270.

Among other things, the memory 250 may be used to store instructions, that when executed by the processor 270 of the communication system 200, perform the methods as provided herein some embodiments of the present disclosure, one or more of the components of the communication system 200 may include a memory. In one example, each component in the communication system 200 may have its own memory. Continuing this example, the memory 250 may be a part of each component in the communication system 200. In some embodiments of the present disclosure, the memory 250 may be located across the communication network 216 for access by one or more components in the communication system 200. In any event, the memory 250 may be used in connection with the execution of application programming or instructions by the processor 270, and for the temporary or long-term storage of program instructions and/or data. As examples, the memory 250 may include Random-Access Memory (RAM), Dynamic RAM (DRAM), Static RAM (SDRAM) or other solid-state memory. Alternatively, or in addition, the memory 250 may be used as data storage and can include a solid-state memory device or devices. Additionally, or alternatively, the memory 250 used for data storage may include a hard disk drive or other random-access memory. In some embodiments of the present disclosure, the memory 250 may store information associated with a user, a timer, rules, recorded audio information, recorded video information and the like. For instance, the memory 250 may be used to store predetermined speech characteristics, private conversation characteristics, video characteristics, information related to mute activation/deactivation, times associated therewith, combinations thereof and the like.

The network interface 264 includes components for connecting the conferencing server 244 to the communication network 216. In some embodiments of the present disclosure, a single network interface 264 connects the conferencing server 244 to multiple networks. In some embodiments of the present disclosure, a single network interface 264 connects the conferencing server 244 to one network and an alternative network interface is provided to connect the conferencing server 244 to another network. The network interface 264 may include a communication modem, a communication port or any other type of device adapted to condition packets for transmission across the communication network 216 to one or more destination communication devices (not shown), as well as condition received packets for processing by the processor 270. Examples of network interfaces include, without limitation, a network interface card, a wireless transceiver, a modem, a wired telephony port, a serial or parallel data port, a radio frequency broadcast transceiver, a Universal Serial Bus (USB) port or other wired or wireless communication network interfaces.

The type of network interface 264 utilized may vary according to the type of network which the conferencing server 244 is connected, if at all. Exemplary communication networks 216 to which the conferencing server 244 may connect via the network interface 264 include any type and any number of communication mediums and devices which are capable of supporting communication events (also referred to as “phone calls”, “messages”, “communications” and “communication sessions” herein), such as voice calls, video calls, chats, e-mails, Teletype (TTY) calls, multimedia sessions or the like. In situations where the communication network 216 is composed of multiple networks, each of the multiple networks may be provided and maintained by different network service providers. Alternatively, two or more of the multiple networks in the communication network 216 may be provided and maintained by a common network service provider or a common enterprise in the case of a distributed enterprise network.

The conference mixer(s) 249 as well as other conferencing infrastructure can include hardware and/or software resources of the conferencing system 142 that provide the ability to hold multi-party calls, conference calls and/or other collaborative communications. As can be appreciated, the resources of the conferencing system 142 may depend on the type of multi-party call provided by the conferencing system 142. Among other things, the conferencing system 142 may be configured to provide conferencing of at least one media type between any number of the participants. The conference mixer(s) 249 may be assigned to a particular multi-party call for a predetermined amount of time. In one embodiment of the present disclosure, the conference mixer(s) 249 may be configured to negotiate codecs with each of the communication devices 108A-108N participating in a multi-party call. Additionally, or alternatively, the conference mixer(s) 249 may be configured to receive inputs (at least including audio inputs) from each participating communication device 108A-108N and mix the received inputs into a combined signal which can be provided to each of the communication devices 108A-108N in the multi-party call.

The audio recorder 245 records voice samples of the user. The voice samples can be previously stored in database 246 or registration module 247 for future use.

The audio analyzer 243 is also used to identify voice attributes of the recorded voice sample. The voice attributes may include but are not limited to a pitch, a tone, a volume, an intensity, a vocal fry, a rhythm, a texture, an intonation, etc. According to embodiments of the present disclosure, the speech of each of the participants is represented as a waveform. This waveform is captured in a sound format, such as, but not limited to Audio Video Interleaved (AVI), Motion Picture Experts Group-1 Audio Layer-3 (MP3), etc. by the audio analyzer 243 using the artificial intelligence module 275. Thus, the voice print is a waveform representation of sound of the participant's speech

The artificial intelligence module 275 uses a machine learning model that can be applied to the voice attributes along with a perception of desired voices. When a user selects a particular perception, the corresponding voice attributes for that perception are then applied to the user's voice sample and the attributes of the user's voice sample are manipulated accordingly. The voice attribute manipulation module 271 is used to manipulate or change the voice attributes of recorded voice samples.

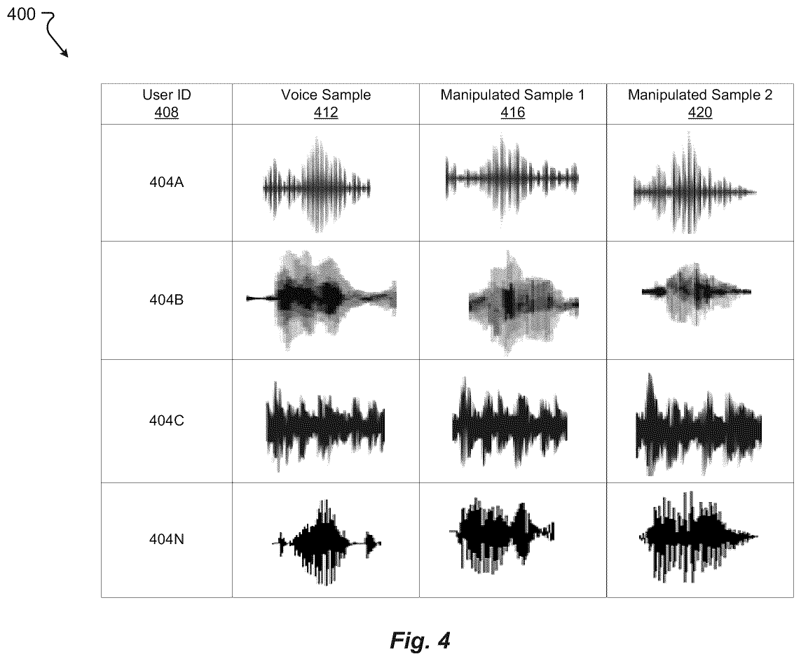

FIG. 4 is a tabular representation 400 of database entries provided by the participants or retrieved automatically from one or more data sources and used for voice attribute manipulation during a communication session according to embodiments of the present disclosure. As illustrated in FIG. 4, the tabular representation 400 includes database entries 404A-404N each including registered information, such as but not limited to a user ID 408, a voice sample 412, a manipulated voice sample 1 416 and a manipulated voice sample 2 420. The registered information may also include voice attribute values selected by the user for various voice attributes. More information may be stored in each of the database entries 404 without departing from the spirit and scope of the present disclosure. The voice attribute manipulation module 271 is used to generate the manipulated voice sample 1 416 and the manipulated voice sample 2 420 for each of the users. The manipulated voice samples are based on changes to the voice attributes of the voice sample 412 for each of the users.

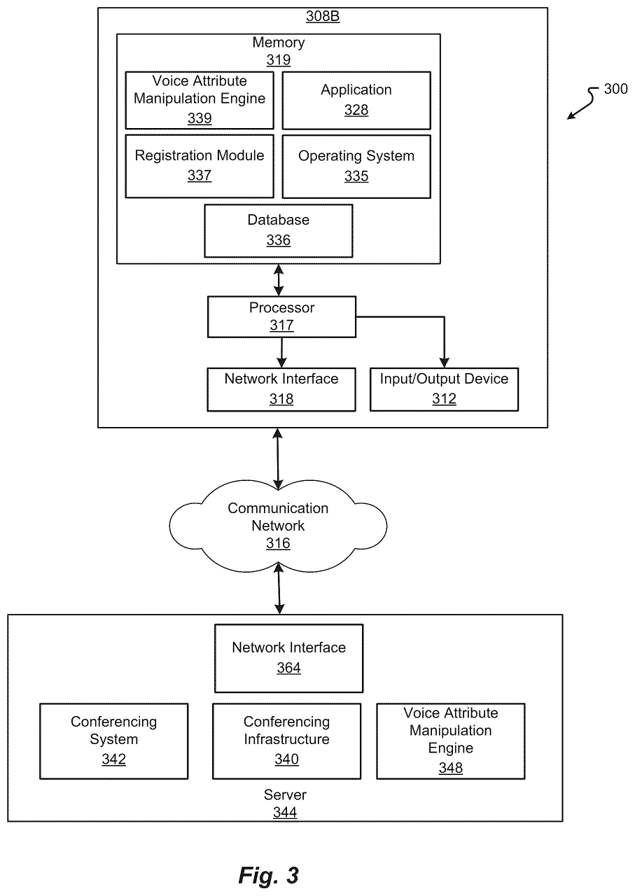

Referring back to FIG. 2, the communication system 200 further includes the communication device 208B which includes the network interface 218, the processor 217, the memory 219 including at least the application 128 and the input/output device 212. A detailed description of the communication device 208B is provided in FIG. 3.

FIG. 3 is a block diagram of an illustrative communication device 308B provided in a communication system 300 used for voice attribute manipulation during a communication session according to embodiments of the present disclosure. The communication system 300 includes the communication device 308B capable of allowing users to interact with the conferencing server 344 is shown in FIG. 3. The depicted communication device 308B includes a processor 317, a memory 319, an input/output device 312, a network interface 318, a database 336, an operating system 335, an application 328, a voice attribute manipulation engine 339 and a registration module 337. Although the details of only one communication device 308B are depicted in FIG. 3, one skilled in the art will appreciate that one or more other communication devices may be equipped with similar or identical components as the communication device 308 depicted in detail. Components shown in FIG. 3 may correspond to those shown and described in FIGS. 1A, 1B and 2.

The input/output device 312 can enable users to interact with the communication device 308B. Exemplary user input devices which may be included in the input/output device 312 include, without limitation, a button, a mouse, a trackball, a rollerball, an image capturing device or any other known type of user input device. Exemplary user output devices which may be included in the input/output device 312 include without limitation, a speaker, a light, a Light Emitting Diode (LED), a display screen, a buzzer or any other known type of user output device. In some embodiments of the present disclosure, the input/output device 312 includes a combined user input and user output device, such as a touch-screen. Using the input/output device 312, a user may configure settings via the application 328 for entering values for the voice attributes, for example.

The processor 317 may include a microprocessor, a CPU, a collection of processing units capable of performing serial or parallel data processing functions, and the like. The processor 317 interacts with the memory 319, the input/output device 312 and the network interface 318 and may perform various functions of the application 328, the operating system 335, the voice attribute manipulation engine 339 and the registration module 337.

The memory 319 may include a number of applications such as the application 328 or executable instructions such as the operating system 335 that are readable and executable by the processor 317. For example, the memory 319 may include instructions in the form of one or more modules and/or applications. The memory 319 may also include data and rules in the form of one or more settings for thresholds that can be used by the application 328, the operating system 335, the voice attribute manipulation engine 339, the registration module 337 and the processor 317.

The operating system 335 is a high-level application which enables the various other applications and modules to interface with the hardware components (e.g., the processor 317, the network interface 318 and the input/output device 312 of the communication device 308B). The operating system 335 also enables the users of the communication device 308B to view and access applications and modules in the memory 319 as well as any data, including settings, recorded voice samples, manipulated voice samples, selected voice attributes by the user, etc. In addition, the application 328 may enable other applications and modules to interface with hardware components of the communication device 308B.

The voice attribute manipulation engine 339 includes several components, including an audio analyzer, a voice recorder, an artificial intelligence module and a voice attribute manipulation module (not shown). The audio analyzer is used to identify incoming audio signals from the participant voice information. According to an alternative embodiment of the present disclosure, the audio analyzer may include a voice changer application, or it might interface with a third-party voice changer application that can change various voice attributes by exposing Application Programming Interface (API)s. According to embodiments of the present disclosure, the audio analyzer may be part of the application 328 (e.g., a conferencing application). The audio analyzer may also interface with audio/sound drivers of the operating system 335 through appropriate APIs in order to identify the incoming audio signals. According to an alternative embodiment of the present disclosure, the audio analyzer may also interface with some other component(s) deployed remotely, e.g., in a cloud environment in order to identify the incoming audio signals. When an audio signal is transmitted from the input/output device 312 such as the microphones and received in digital format by the communication device 308B, the audio signal is converted from digital to analog sound waves by a digital to analog converter (not shown) of the audio analyzer.

The registration module 337 is provided for storing the participant's voice samples and manipulated voice samples as discussed in greater detail above. The communication system 300 further includes the conferencing server 344 including at least a network interface 364, a conferencing system 342, conferencing infrastructure 340 and a voice attribute manipulation engine 348. A detailed description of the conferencing server 344 is provided in FIG. 2 discussed above.

Although some applications and modules may be depicted as software instructions residing in the memory 319 and those instructions are executable by the processor 317, one skilled in the art will appreciate that the applications and modules may be implemented partially or totally as hardware or firmware. For example, an Application Specific Integrated Circuit (ASIC) may be utilized to implement some, or all of the functionality discussed herein.

Although various modules and data structures for the disclosed systems and methods are depicted as residing on the communication device 308B, one skilled in the art can appreciate that one, some, or all of the depicted components of the communication device 308B may be provided by other software or hardware components. For example, one, some or all of the depicted components of the communication device 308B may be provided by systems operating on the conferencing server 344. In the illustrative embodiments of the present disclosure shown in FIG. 3, the communication device 308B includes all the necessary logic for the systems and methods disclosed herein so that the systems and methods are performed at the communication device 308B. Thus, the communication device 308B can perform the methods disclosed herein without use of logic on the conferencing server 344.

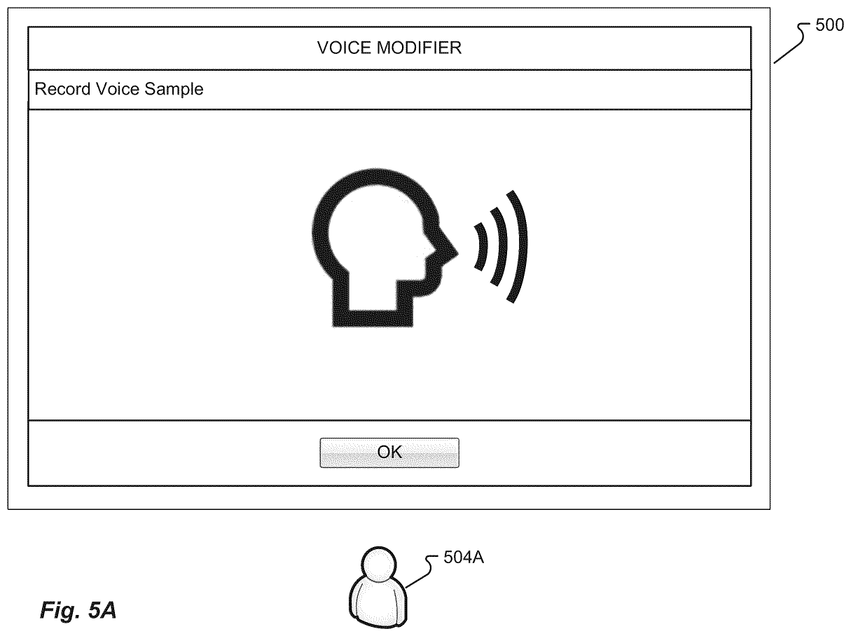

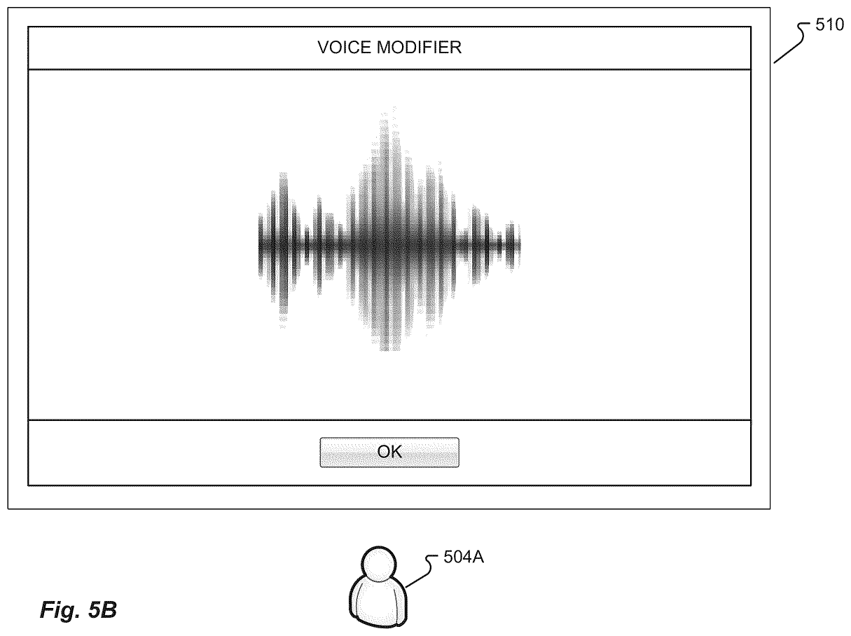

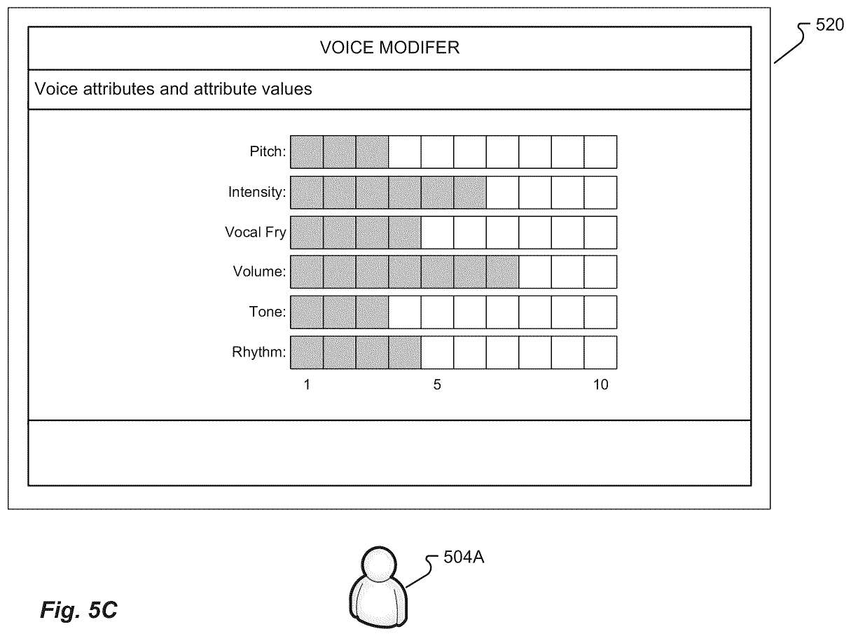

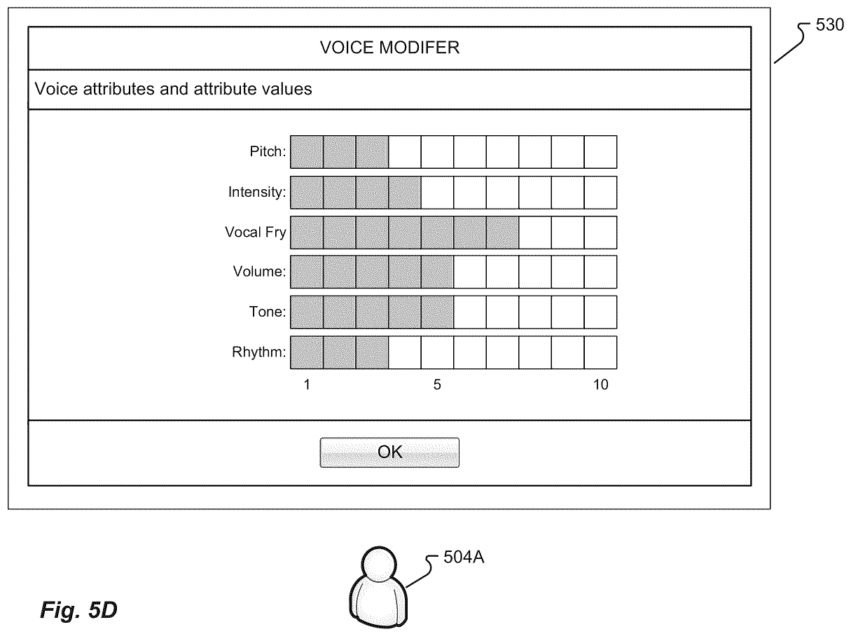

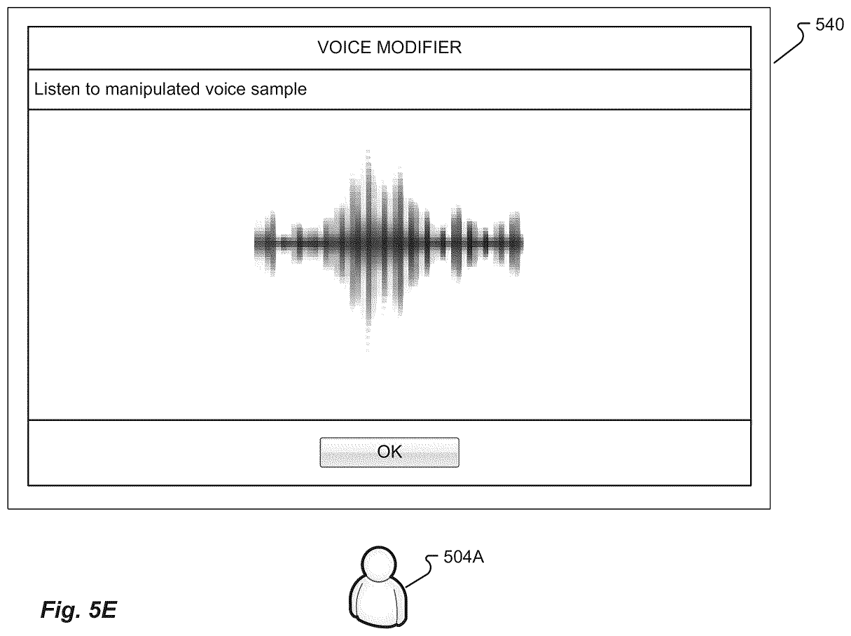

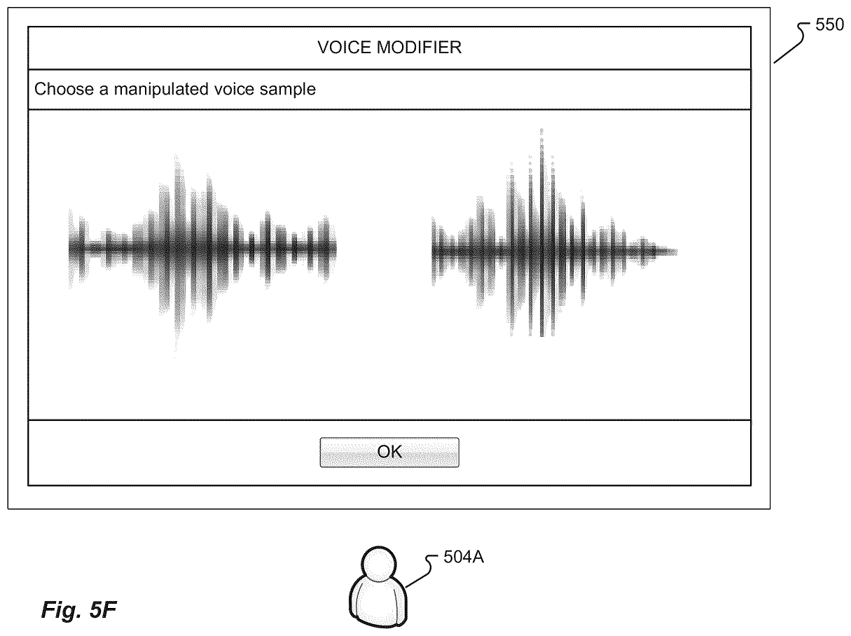

FIG. 5A-5F illustrate aspects of voice modifier interfaces that can be displayed on a communication device used for voice attribute manipulation during a communication session according to embodiments of the present disclosure. FIG. 5A illustrates a voice modifier interface 500 that can be displayed on a communication device used for voice attribute manipulation during a communication session according to an embodiment of the present disclosure. As illustrated in FIG. 5A, user 504A is requested to “Please Record Voice Sample.” According to embodiments of the present disclosure, user 504A can have a voice sample registered and stored in database 246 or registration module 247. According to other embodiments of the present disclosure, user 504A could record a new voice sample, replace a stored voice sample, add another voice sample in his profile, etc. FIG. 5B illustrates a voice modifier interface 510 that can be displayed on a communication device used for voice attribute manipulation during a communication session according to an embodiment of the present disclosure. As illustrated in FIG. 5B a waveform of the recorded voice sample is displayed to user 504A.

FIG. 5C illustrates a voice modifier interface 520 that can be displayed on a communication device used for voice attribute manipulation during a communication session according to an embodiment of the present disclosure. As illustrated in FIG. 5C, voice attributes and voice attribute values for the record voice sample are displayed to user 504A. As illustrated, the voice attributes of pitch, intensity, vocal fry, volume, tone and rhythm are displayed. The pitch has a value of three (3), the intensity has a value of six (6), the vocal fry has a value of four (4), the volume has a value of seven (7), the tone has a value of three (3) and the rhythm has a value of 4 (four).

FIG. 5D illustrates a voice modifier interface 530 that can be displayed on a communication device used for voice attribute manipulation during a communication session according to an embodiment of the present disclosure. As illustrated in FIG. 5D, the user 504A is given the opportunity to change one or more of the voice attribute values. As illustrated, the pitch maintains a value of three (3), the value of the intensity decreased from a value of six (6) to a value of four (4), the value of the vocal fry increased from a value of four (4) to a value of seven (7), the value of the volume decreased from a value of seven (7) to a value of five (5), the value of the tone increased from a value of three (3) to a value of five (5) and the value of the rhythm decreased from a value of 4 (four) to a value of three (3).

FIG. 5E illustrates a voice modifier interface 540 that can be displayed on a communication device used for voice attribute manipulation during a communication session according to an embodiment of the present disclosure. As illustrated in FIG. 5E, the user 504A is requested to listen to the manipulated voice sample. The manipulated voice sample illustrated in FIG. 5E is the same as the manipulated sample 1 for user ID 404A illustrated in FIG. 4.

FIG. 5F illustrates a voice modifier interface 540 that can be displayed on a communication device used for voice attribute manipulation during a communication session according to an embodiment of the present disclosure. As illustrated in FIG. 5F, the user 504A is given the choice of selection of a manipulated voice sample. The manipulated voice samples illustrated in FIG. 5F are the same as manipulated sample 1 and manipulated sample 2 for user ID 404A illustrated in FIG. 4.

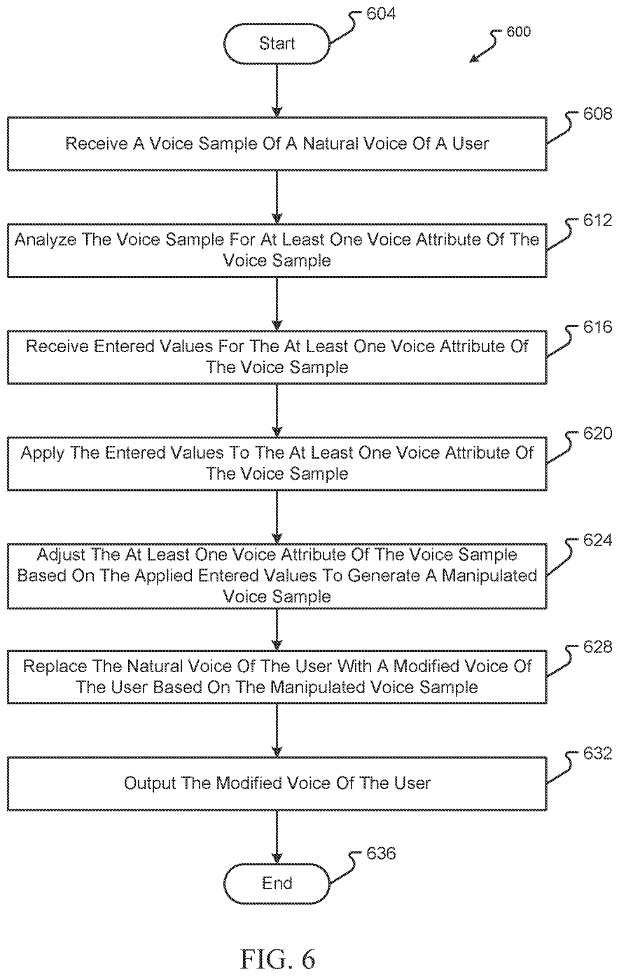

FIG. 6 is a flow diagram of a method 600 used for voice attribute manipulation during a communication session according to embodiments of the present disclosure. While a general order of the steps of method 600 is shown in FIG. 6, method 600 can include more or fewer steps or can arrange the order of the steps differently than those shown in FIG. 6. Further, two or more steps may be combined into one step. Generally, method 600 starts with a START operation at step 604 and ends with an END operation at step 636. Method 600 can be executed as a set of computer-executable instructions executed by a data-processing system and encoded or stored on a computer readable medium. Hereinafter, method 600 shall be explained with reference to the systems, the components, the modules, the software, the data structures, the user interfaces, etc. described in conjunction with FIGS. 1-5F.

Method 600 starts with the START operation at step 604 and proceeds to step 608, where the processor 270, the voice recorder 245 and/or the database 246/registration module 247 of the conferencing server 244 receives a voice sample of a natural voice of a user. The received voice sample could be a real time recording of the voice sample or a stored voice sample. After receiving the voice sample of a natural voice of a user at step 608, method 600 proceeds to step 612, where the processor 270 and the audio analyzer 243 of the conferencing server 244 analyzes the voice sample for at least one voice attribute of the voice sample. After analyzing the voice sample for at least one voice attribute of the voice sample at step 612, method 600 proceeds to step 616 where the processor 270 of the conferencing server 244 receives entered values for the at least one voice attribute of the voice sample. After receiving the entered values for the at least one voice attribute of the voice sample at step 616, method 600 proceeds to step 620, where the processor of the conferencing server 244 applies the entered values to the at least one voice attribute of the voice sample. After applying the entered values to the at least one voice attribute of the voice sample at step 620, method 600 proceeds to step 624, where the processor 270 and the voice attribute manipulation module 241 of the conferencing server 244 adjusts the at least one voice attribute of the voice sample based on the applied entered values to generate a manipulated voice sample. After adjusting the at least one voice attribute of the voice sample based on the applied entered values to generate a manipulated voice sample at step 624, method 600 proceeds to step 628, where the processor 270 of the conferencing server 244 replaces the natural voice of the user with a modified voice of the user based on the manipulated voice sample. After replacing the natural voice of the user with a modified voice of the user based on the manipulated voice sample at step 628, method 600 proceeds to step 632 where the processor 632 of the conferencing server 244 outputs the modified voice of the user. After outputting the modified voice of the user at step 632, method 600 ends with END operation at step 636.

The exemplary systems and methods of this disclosure have been described in relation to a distributed processing network. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments and/or configurations illustrated herein show the various components of the system collocated, certain components of the system can be located remotely, at distant portions of a distributed network, such as a LAN and/or the Internet or within a dedicated system. Thus, it should be appreciated, that the components of the system can be combined in to one or more devices, such as a server or collocated on a particular node of a distributed network, such as an analog and/or digital communications network, a packet-switch network or a circuit-switched network. It will be appreciated from the preceding description and for reasons of computational efficiency, that the components of the system can be arranged at any location within a distributed network of components without affecting the operation of the system. For example, the various components can be located in a switch such as a Privat Branch Exchange (PBX) and media server, gateway, in one or more communications devices, at one or more users' premises or some combination thereof. Similarly, one or more functional portions of the system could be distributed between a communications device(s) and an associated computing device.

Furthermore, it should be appreciated that the various links connecting the elements can be wired or wireless links, or any combination thereof or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics and may take the form of acoustic or light waves, such as those generated during radio-wave and infrared data communications.

Also, while the flowcharts have been discussed and illustrated in relation to a particular sequence of events, it should be appreciated that changes, additions and omissions to this sequence can occur without materially affecting the operation of the disclosed embodiments, configuration and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL) special purpose computer, any comparable means or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids and others), and other hardware known in the art. Some of these devices include processors (e.g., a single or multiple microprocessors), memory, nonvolatile storage, input devices and output devices. Furthermore, alternative software implementations including, but not limited to, distributed processing or component/object distributed processing, parallel processing or virtual machine processing can also be constructed to implement the methods described herein.

In yet another embodiment of the present disclosure, the disclosed methods may be readily implemented in conjunction with software using object or object-oriented software development locations that provide portable source code that can be used on a variety of computer or workstation platforms. Alternatively, the disclosed system may be implemented partially or fully in hardware using standard logic circuits or Very Large-scale Integration (VLSI) design. Whether software or hardware is used to implement the systems in accordance with this disclosure is dependent on the speed and/or efficiency requirements of the system, the particular function and the particular software or hardware systems or microprocessor or microcomputer systems being utilized.

In yet another embodiment of the present disclosure, the disclosed methods may be partially implemented in software that can be stored on a storage medium, executed on programmed general-purpose computer with the cooperation of a controller and memory, a special purpose computer, a microprocessor or the like. In these instances, the systems and methods of this disclosure can be implemented as program embedded on personal computer such as an applet, JAVA® or Computer-generated Imagery (CGI) script, as a resource residing on a server or computer workstation, as a routine embedded in a dedicated measurement system, system component or the like. The system can also be implemented by physically incorporating the system and/or method into a software and/or hardware system.

Although the present disclosure describes components and functions implemented in the aspects, embodiments and/or configurations with reference to particular standards and protocols, the aspects, embodiments and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments and/or configurations, includes components, methods, processes, systems and/or apparatus substantially as depicted and described herein, including various aspects, embodiments, configurations embodiments, sub combinations and/or subsets thereof. Those of skill in the art will understand how to make and use the disclosed aspects, embodiments and/or configurations after understanding the present disclosure. The present disclosure, in various aspects, embodiments and/or configurations, includes providing devices and processes in the absence of items not depicted and/or described herein or in various aspects, embodiments and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments and/or configurations for the purpose of streamlining the disclosure. The features of the aspects, embodiments and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment and/or configuration. Thus, the following claims are hereby incorporated into this Detailed Description, with each claim standing on its own as a separate preferred embodiment of the disclosure.

Moreover, though the description has included description of one or more aspects, embodiments and/or configurations and certain variations and modifications, other variations, combinations and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein and without intending to publicly dedicate any patentable subject matter.

Embodiments of the present disclosure include a method including receiving, by a processor, a voice sample of a natural voice of a user, analyzing, by the processor, the voice sample for at least one attribute of the voice sample, receiving, by the processor, entered values for the at least one attribute of the voice sample and applying, by the processor, the entered values to the at least one attribute of the voice sample. The method also includes adjusting, by the processor, the at least one attribute of the voice sample based on the applied entered values to generate a manipulated voice sample, replacing, by the processor, the natural voice of the user with a modified voice of the user based on the manipulated voice sample and outputting, by the processor, the modified voice of the user.

Aspects of the above method include wherein the manipulated voice sample is generated using a trained algorithm for machine learning.

Aspects of the above method further include displaying the at least one attribute of the voice sample.

Aspects of the above method include wherein the displayed at least one attribute of the voice sample includes a scale of values for adjusting the at least one attribute of the voice sample.

Aspects of the above method further include replacing a natural voice of a speaker with a modified voice for a speaker during a communication session.

Aspects of the above method include wherein the communication session is a conference call.

Aspects of the above method further include providing notification to other participants to the communication session that the speaker is using the modified voice.

Aspects of the above method include wherein the entered values for the at least one attribute of the voice sample is based on known attributes of desired voices.

Aspects of the above method include wherein the at least one attribute includes at least one of pitch, tone, volume, intensity, vocal fry, rhythm, texture and intonation.

Aspects of the above method further include storing, by the processor, the entered values for the at least one attribute of the voice sample in a user profile.

Aspects of the above method include wherein the modified voice of the user based on the manipulated voice sample is substituted for the natural voice of the user in real time.

Embodiments of the present disclosure include a system including one or more processors and a memory coupled with and readable by the one or more processors and having stored therein a set of instructions which, when executed by the one or more processors, causes the one or more processors to receive a voice sample of a natural voice of a user, analyze the voice sample for at least one attribute of the voice sample, receive entered values for the at least one attribute of the voice sample and apply the entered values to the at least one attribute of the voice sample. The one or more processors are further caused to adjust the at least one attribute of the voice sample based on the applied entered values to generate a manipulated voice sample, replace the natural voice of the user with a modified voice of the user based on the manipulated voice sample and output the modified voice of the user.

Aspects of the above system include wherein the manipulated voice sample is generated using a trained algorithm for machine learning.

Aspects of the above system include wherein the one or more processors is further caused to display the at least one attribute of the voice sample.

Aspects of the above system include wherein the displayed at least one attribute of the voice sample includes a scale of values for adjusting the at least one attribute of the voice sample.

Aspects of the above system include wherein the one or more processors is further caused to replace a natural voice of a speaker with a modified voice for the speaker during a communication session.

Aspects of the above system include wherein the communication session is a conference call.

Aspects of the above system include wherein the entered values for the at least one attribute of the voice sample is based on known attributes of desired voices.

Aspects of the above system include wherein the at least one attribute includes at least one of pitch, tone, volume, intensity, vocal fry, rhythm, texture and intonation.

Embodiments of the present disclosure include computer readable medium including microprocessor executable instructions that, when executed by the microprocessor, perform the functions of receive a voice sample of a natural voice of a user, analyze the voice sample for at least one attribute of the voice sample, receive entered values for the at least one attribute of the voice sample and apply the entered values to the at least one attribute of the voice sample. The microprocessor further performs the functions of adjust the at least one attribute of the voice sample based on the applied entered values to generate a manipulated voice sample, replace the natural voice of the user with a modified voice of the user based on the manipulated voice sample and output the modified voice of the user.

What is claimed is:

1. A method, comprising:
receiving, by a processor, a voice sample of a natural voice of a user;
analyzing, by the processor, the voice sample for at least one attribute of the voice sample;
receiving, by the processor, entered values for the at least one attribute of the voice sample;
applying, by the processor, the entered values to the at least one attribute of the voice sample;
adjusting, by the processor, the at least one attribute of the voice sample based on the applied entered values to generate a manipulated voice sample;
replacing, by the processor, the natural voice of the user with a modified voice of the user based on the manipulated voice sample; and
outputting, by the processor, the modified voice of the user.

2. The method according to claim 1, wherein the manipulated voice sample is generated using a trained algorithm for machine learning.

3. The method according to claim 1, further comprising displaying the at least one attribute of the voice sample.

4. The method according to claim 3, wherein the displayed at least one attribute of the voice sample includes a scale of values for adjusting the at least one attribute of the voice sample.

5. The method according to claim 1, further comprising replacing a natural voice of a speaker with a modified voice for a speaker during a communication session.

6. The method according to claim 5, wherein the communication session is a conference call.

7. The method according to claim 5, further comprising providing notification to other participants to the communication session that the speaker is using the modified voice.

8. The method according to claim 1, wherein the entered values for the at least one attribute of the voice sample is based on known attributes of desired voices.

9. The method according to claim 1, wherein the at least one attribute includes at least one of pitch, tone, volume, intensity, vocal fry, rhythm, texture and intonation.

10. The method according to claim 1, further comprising storing, by the processor, the entered values for the at least one attribute of the voice sample in a user profile.

11. The method according to claim 1, wherein the modified voice of the user based on the manipulated voice sample is substituted for the natural voice of the user in real time.

12. A system, comprising:
one or more processors; and
a memory coupled with and readable by the one or more processors and having stored therein a set of instructions which, when executed by the one or more processors, causes the one or more processors to:
receive a voice sample of a natural voice of a user;
analyze the voice sample for at least one attribute of the voice sample;
receive entered values for the at least one attribute of the voice sample;
apply the entered values to the at least one attribute of the voice sample;
adjust the at least one attribute of the voice sample based on the applied entered values to generate a manipulated voice sample;
replace the natural voice of the user with a modified voice of the user based on the manipulated voice sample; and
output the modified voice of the user.

13. The system according to claim 12, wherein the manipulated voice sample is generated using a trained algorithm for machine learning.

14. The system according to claim 12, wherein the one or more processors is further caused to display the at least one attribute of the voice sample.

15. The system according to claim 14, wherein the displayed at least one attribute of the voice sample includes a scale of values for adjusting the at least one attribute of the voice sample.

16. The system according to claim 12, wherein the one or more processors is further caused to replace a natural voice of a speaker with a modified voice for the speaker during a communication session.

17. The system according to claim 16, wherein the communication session is a conference call.

18. The system according to claim 12, wherein the entered values for the at least one attribute of the voice sample is based on known attributes of desired voices.

19. The system according to claim 12, wherein the at least one attribute includes at least one of pitch, tone, volume, intensity, vocal fry, rhythm, texture and intonation.

20. A computer readable medium comprising microprocessor executable instructions that, when executed by the microprocessor, perform the following functions:
receive a voice sample of a natural voice of a user;
analyze the voice sample for at least one attribute of the voice sample;
receive entered values for the at least one attribute of the voice sample;
apply the entered values to the at least one attribute of the voice sample;
adjust the at least one attribute of the voice sample based on the applied entered values to generate a manipulated voice sample;
replace the natural voice of the user with a modified voice of the user based on the manipulated voice sample; and
output the modified voice of the user.
